(19) United States
(12) Patent Application Publication
(10) Pub. No.: US 2017/0028850 A1
(43) Pub. Date: Feb. 2, 2017

(54) VEHICLE DISPLAY SYSTEMS

(71) Applicant: Ford Global Technologies, LLC, Dearborn, MI (US)

(72) Inventors: Kenneth James MILLER, Canton, MI (US); Douglas Raymond MARTIN, Canton, MI (US); William Paul PERKINS, Dearborn, MI (US)

(21) Appl. No.: 14/814,677

(22) Filed: Jul. 31, 2015

(51) Int. Cl. B60K 35/00

(52) U.S. Cl. CPC B60K 35/00; B60K 2350/1096; B60K 2350/352

(57) ABSTRACT

A vehicle display system may include an interface that presents selectable icons. The system also includes a controller that receives vehicle condition data, assigns a relevancy level to at least one of the icons associated with a vehicle feature based on the data, and selects a display form for the at least one of the icons based on the relevancy level.

### TECHNICAL FIELD

Disclosed herein are vehicle display systems.

### BACKGROUND

Vehicles often include many systems that allow a driver to interact with the vehicle and its systems. In particular, vehicles often provide a variety of devices and techniques to control and monitor the vehicle's various subsystems and functions. As the number of features and functions available to a driver increases, so does the complexity of the user interface used to control these features and functions. Thus, an enhanced and flexible system for presenting vehicle features to the user may be desired.

### SUMMARY

A vehicle display system may include an interface configured to present selectable icons, and a controller programmed to receive vehicle condition data, to assign a relevancy level to at least one of the icons associated with a vehicle feature based on the data, and to select a display form for the at least one of the icons based on the relevancy level.

A vehicle display system may include an interface configured to present a collision-avoidance icon, and a controller programmed to receive vehicle position data indicative of a followed vehicle position, to assign a relevancy level to the icon based on the followed vehicle position, and to select a display form for the icon based on the relevancy level.

A vehicle display system may include an interface configured to present an icon that permits control of vehicle speaker volume, and a controller programmed to alter a display form of the icon based on an assigned relevancy level that changes as received data indicative of an emergency situation changes.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIGS. 1A and 1B illustrate an example diagram of a system that may be used to provide telematics services to a vehicle;

FIG. 2 illustrates an example block diagram of a portion of the vehicle display system;

FIG. 3 illustrates an example graph of feature relevancy level;

FIG. 4 illustrates an example vehicle display;

FIG. 5 illustrates an example process for the vehicle display system;

FIG. 6 illustrates an example graph of feature relevancy level;

FIG. 7 illustrates another example vehicle display;

FIG. 8 illustrates another example process for the vehicle display system;

FIG. 9 illustrates another example graph of vehicle feature relevancy;

FIG. 10 illustrates another example vehicle display;

FIG. 11 illustrates another example process for the vehicle display system;

FIG. 12 illustrates another example graph of vehicle feature relevancy;

FIGS. 13A and 13B each illustrates another example vehicle display;

FIG. 14 illustrates another example process for the vehicle display system;

FIG. 15 illustrates another example process for the vehicle display system; and

FIG. 16 illustrates another example process for the vehicle display system;

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Vehicle interface systems may provide various options for accessing and interacting with vehicle systems. These systems may include all-wheel drive features, door-ajar alerts, collision-avoidance alerts, volume controls, etc. Customers may become overwhelmed by the options and information provided on the human-machine interface (HMI) within the vehicle. At certain times while the vehicle is in use, certain ones of these features may be more relevant to the current driving conditions than others based on certain vehicle data.

A display system is described herein to use vehicle data to determine a display form of a selectable display icon. The display form may be selected from a group of certain sizes, animations, colors, etc. A relevancy level may then be used to determine the display form for the associated icon. By displaying icons in terms of their relevancy, user interaction with the display may increase and distractions to the user during driving may decrease. Furthermore, encouraging use of a vehicle features at an appropriate time may enhanced driving experiences.

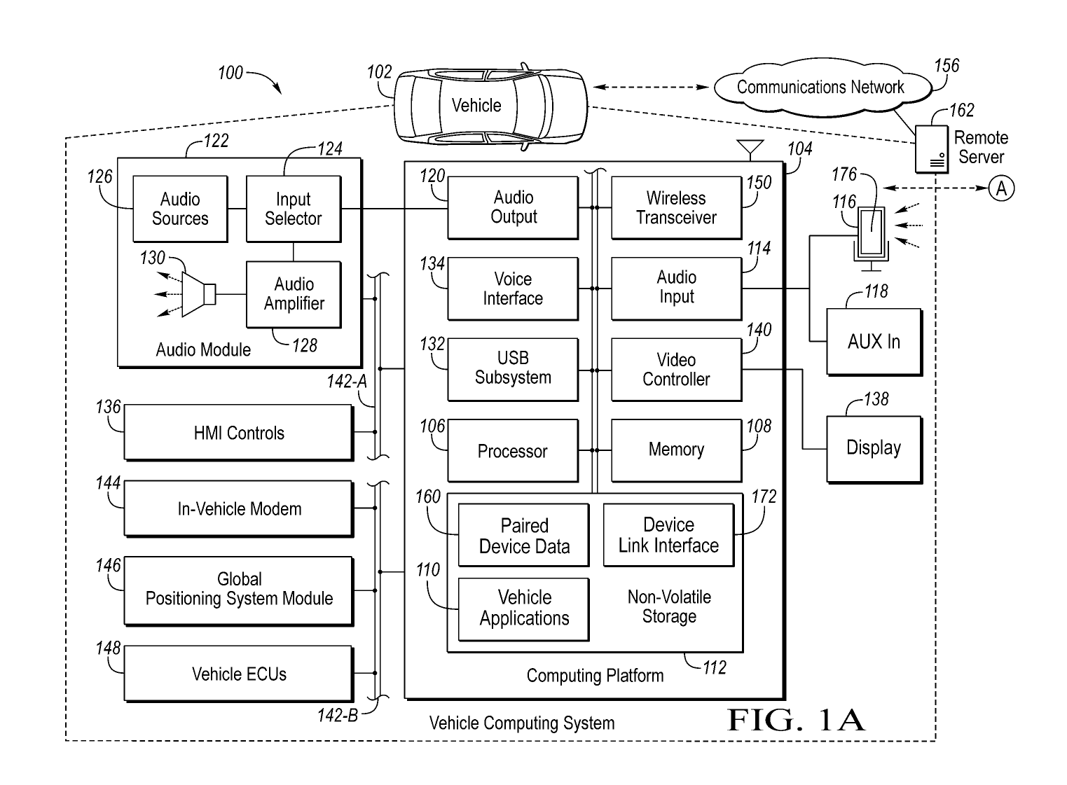

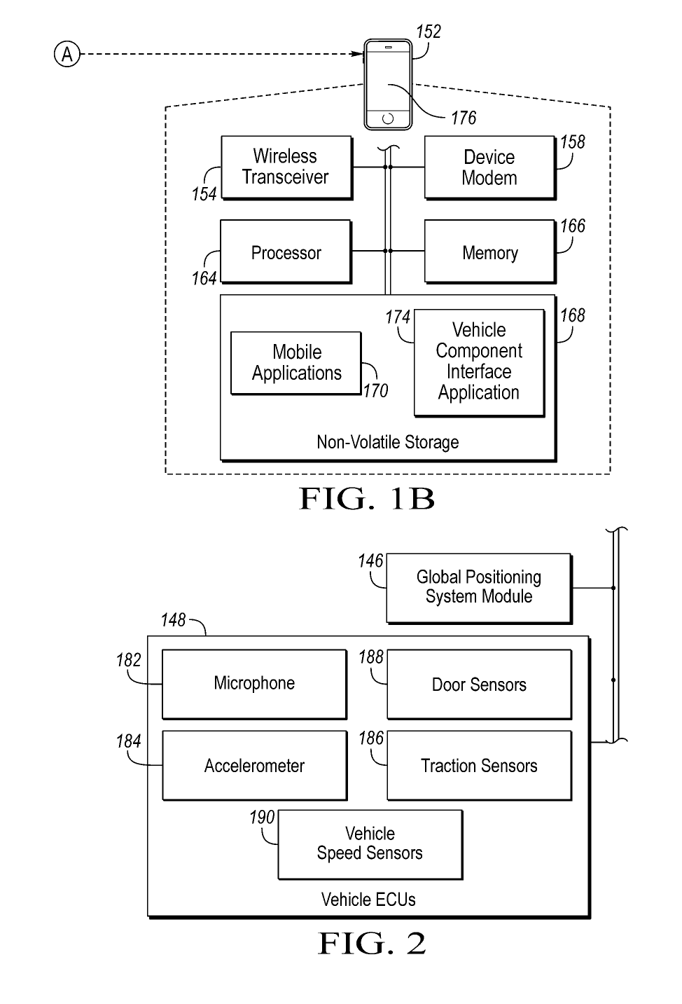

FIGS. 1A and 1B illustrate an example diagram of a system 100 that may be used to provide telematics services to a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 and controllers configured to perform instructions, commands and other routines in support of the processes described herein. For instance, the computing platform 104 may be configured to execute instructions of vehicle applications 110 to provide features such as navigation, accident reporting, satellite radio decoding, hands-free calling and parking assistance. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to grammar associated with available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to cooperate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.), and other sensors such as those shown in FIG. 2, etc.

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134 as well as into display 138 of the computing platform 104. The device link interfaced 172 may also provide the mobile applications 170 with access to vehicle information available to the computing platform 104 via the in-vehicle networks 142. Some examples of device link interfaces 172 include the SYNC APPLINK component of the SYNC system provided by The Ford Motor Company of Dearborn, Mich., the CarPlay protocol provided by Apple Inc. of Cupertino, Calif., or the Android Auto protocol provided by Google, Inc. of Mountain View, Calif. The vehicle component interface application 174 may be once such application installed to the mobile device 152.

The vehicle component interface application 174 of the mobile device 152 may be configured to facilitate access to one or more vehicle 102 features made available for device configuration by the vehicle 102. In some cases, the available vehicle 102 features may be accessible by a single vehicle component interface application 174, in which case such the vehicle component interface application 174 may be configured to be customizable or to maintain configurations supportive of the specific vehicle 102 brand/model and option packages. In an example, the vehicle component interface application 174 may be configured to receive, from the vehicle 102, a definition of the features that are available to be controlled, display a user interface descriptive of the available features, and provide user input from the user interface to the vehicle 102 to allow the user to control the indicated features. As exampled in detail below, an appropriate mobile device 152 to display the vehicle component interface application 174 may be identified (e.g. mobile display 176), and a definition of the user interface to display may be provided to the identified vehicle component interface application 174 for display to the user.

Systems such as the system 100 may require mobile device 152 pairing with the computing platform 104 and/or other setup operations. However, as explained in detail below, a system may be configured to allow vehicle occupants to seamlessly interact with user interface elements in their vehicle or with any other framework-enabled vehicle, without requiring the mobile device 152 or wearable device to have been paired with or be in communication with the computing platform 104.

Additionally, the wireless transceiver 150 may receive and transmit data regarding the vehicle's position to other vehicles in vehicle-to-vehicle communication. The processor 106 may process such incoming vehicle position data. As explained herein, the vehicle position data received from surrounding vehicles may be used to determine whether the vehicle 102 is following too close to a followed vehicle and provide an alert accordingly. That is, if the vehicle 102 is following too closely behind the followed vehicle, an alert may be presented via the display 138.

The remote server 162 and communications network 156 may also facilitate transmission of other vehicle-to-vehicle data such as data acquired from other mobile applications and websites such as Google Maps™, Waze™, etc. In these examples, data may be shared between users and used to determine the location of other vehicles, emergency situations, etc.

FIG. 2 illustrates an example diagram of a portion of the display system 100. As explained above, the vehicle ECU 148 may include certain vehicle systems and control units. The vehicle ECU 148 may include various sensors such as a microphone 182, accelerometer 184, traction sensors 186, door sensors 188, and vehicle speed sensors 190. These various sensors and devices may supply data about the vehicle 102 to the computing platform 104. The microphone 182 may be configured to detect emergency vehicle noise outside of the vehicle 102. That is, the microphone 182 may detect a siren from an emergency vehicle such as a police vehicle. The microphone 182 may be arranged within the vehicle cabin, or may be arranged external to the cabin of the vehicle 102. The microphone 182 may include a processor and be configured to distinguish between ambient noise and siren noise frequency and amplitude profiles.

The microphone 182 may be a wireless microphone configured to communicate with the computing platform 104 via a wireless network. The microphone 182 may also have a wired connection with the computing platform 104 and processor 106 therein. Although not shown specifically in FIG. 2, the microphone 182 may be included in the microphone 116. The microphone 182 may also be integrated in the mobile device 152. The microphone 182 may transmit an audio signal to the audio input 114 and the processor 106 may be configured to determine if the received audio signal includes data representative of a siren, or other alarm.

The accelerometer 184 may be configured to detect an acceleration/deceleration of the vehicle 102. The accelerometer 184 may also be used in conjunction with other vehicle systems and features such as cruise control, power management, etc.

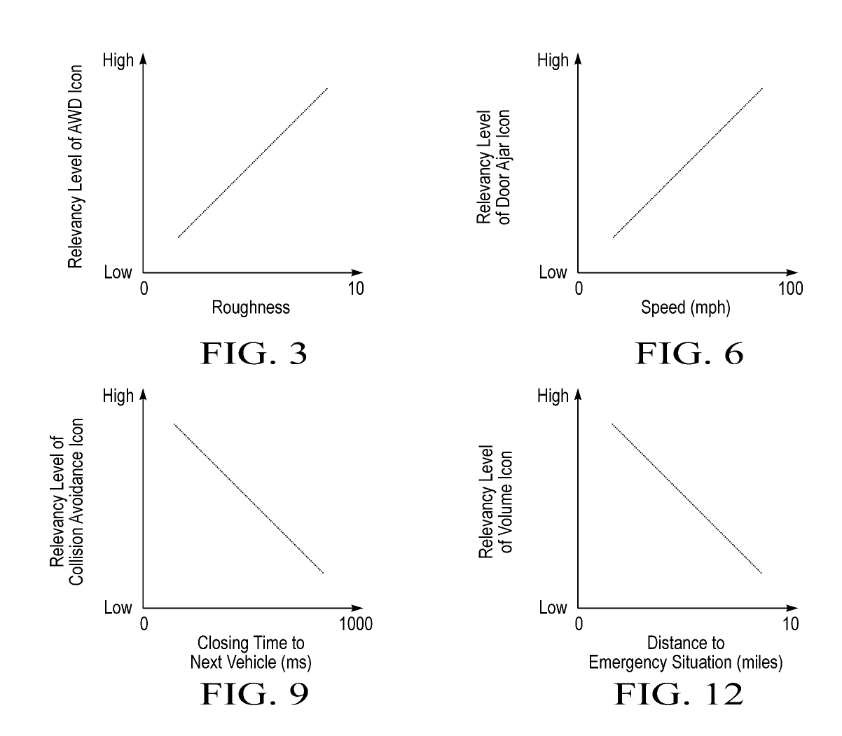

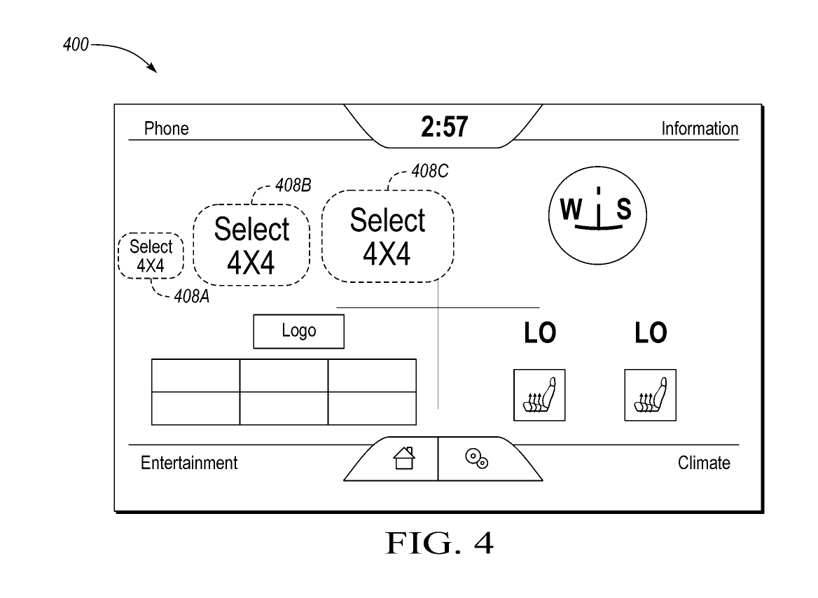

The traction sensors 186 may include various sensors configured to detect when the vehicle 102 is ‘off-road’, or on un-even, slippery, or an otherwise non-typical driving surface where all wheel drive (AWD) or four wheel drive (4WD) (collectively referred to herein as AWD) may be beneficial. The traction sensors 186 may include wheel speed sensors, g-force sensors (including an accelerometer), steering angle sensors, accelerator petal position sensors, etc. These sensors 186 may be capable of detecting when a vehicle is experiencing wheel slipping, unusual impacts at the wheels, etc. In some examples, more than one type of traction sensor 186 may be used to determine whether AWD would be beneficial. This process is described in more detail below with respect to FIGS. 3-4.

The door sensors 188 may be arranged in each of the vehicle doors, which may include a front driver side door, front passenger side door, rear driver side door, rear passenger side door, rear hatch door, etc. The door sensors 188 may include a switch or latch configured to be deflected when the door is completely closed. When the door is not closed, the latch may remain open and may transmit a door-ajar signal to the processor 106 over a wire, or other communication mechanism.

While the sensors shown in FIG. 2 are shown as part of the vehicle ECUs 148, the sensors may be integrated in other systems, or be stand-alone systems. Further, the sensors may communicate via wired or wireless connections with the various system components.

Each of the vehicle sensors in FIG. 2 may provide data indicative of a vehicle conditions (e.g., speed, door-ajar, presence of emergency vehicle, off-road driving surface, etc.) These vehicle conditions may affect or cause an increase of relevance for certain vehicle features. For example, an indication of a bumpy road by the traction sensors 186 may indicate that AWD may be preferred. Certain vehicle features may be more or less relevant depending on various vehicle conditions. For example, if a door is ajar while the vehicle 102 is traveling at five miles per hour (mph), then a door-ajar alert may be less relevant. However, if the vehicle 102 were traveling at 80 mph, an un-closed door may be of greater concern and have a high relevancy level.

FIG. 3 illustrates an example graph of the feature relevancy level of an AWD icon as a function of speed. The AWD icon (as shown as icon 408 in FIG. 4) may include an AWD icon for AWD vehicles and/or a 4WD icon for 4WD vehicles. During driving, when a rough or bumpy driving surface is recognized by the traction sensors 186, the AWD icon may be presented via the display 138. As the roughness increases, as detected by the traction sensor 186, the relevancy of the AWD icon may also increase. That is, the rougher the road the driving surface, the more relevant the AWD icon may become.

The roughness may be determined using acceleration and anti-lock braking system (ABS) data. Once the ABS detects wheel slipping, acceleration from the accelerometer 184 may be used to detect vertical movement (e.g. bouncing.) The quantity of vertical acceleration (bouncing) may be used to detect a rough or bumpy driving surface. The roughness of a surface may be scaled on a scale of 1-10, with 10 being an extremely rough terrain, such as off-road terrain. A scale of 1 may indicate a very smooth driving surface such as a newly paved road. The greater the magnitude of the bounces and the more bounces per minute, the higher the roughness scale.

The level of relevancy (also referred to herein as relevancy level) for an associated vehicle feature may include a ranking on a certain numerical scale, such as a scale of 1-10. The relevancy level may also be one of a certain relevancy status such as low, medium, or high. In determining a relevancy level, the processor 104 may take into account several factors and data.

Once a relevancy level is established, the display 138 may be updated accordingly. The display update may include a selected display form for specific selectable options, each associated with a controllable vehicle feature. The determined relevancy level may be used to determine the display form for certain icons, or selectable options. In one example, the size of the icon may be increased or decreased based on the relevancy level. The higher the relevancy level, the larger the icon. This may permit increased visibility of the relevant selectable option. Other examples of altering or promoting a certain icon may include placement of the icon relative to other icons. That is, the icon may be arranged above other icons if the feature associated with the icon has a higher relevancy level than the features associated with the other icons. In another example, the icons may be animated. This may include shaking, rotating, pulsating, and/or vibrating the icon to increase visibility of the icon. The icon may scroll across the interface, may fade in or fade out, may include pulsating or rolling stripes, or other patterns, etc. Animated figures, such as an image of a person waving his hands in the air may also be part of the icon animation. Furthermore, audio instructions may also be included and used throughout based on relevancy levels of certain features.

FIG. 4 illustrates an example vehicle display 138 showing an interface 400 having various AWD icons 408. For illustrative purposes, the AWD icons 408 are shown as a small icon 408A, medium icon 408B, and large icon 408C. The various icon sizes may correspond to a level of relevancy for the specific feature presented by the icons. For example, if the AWD feature is of a low relevancy, the small icon 408A may be presented. However, as the relevancy increase, so may the size of the icon. The converse is also true, as the relevancy decreases, so may the size of the icon. Although all three sized icons 708 are shown in FIG. 4, one of the icons may be presented during vehicle operation and the three icons shown in FIG. 4 are to illustrate the variation in sizes of the icons 408.

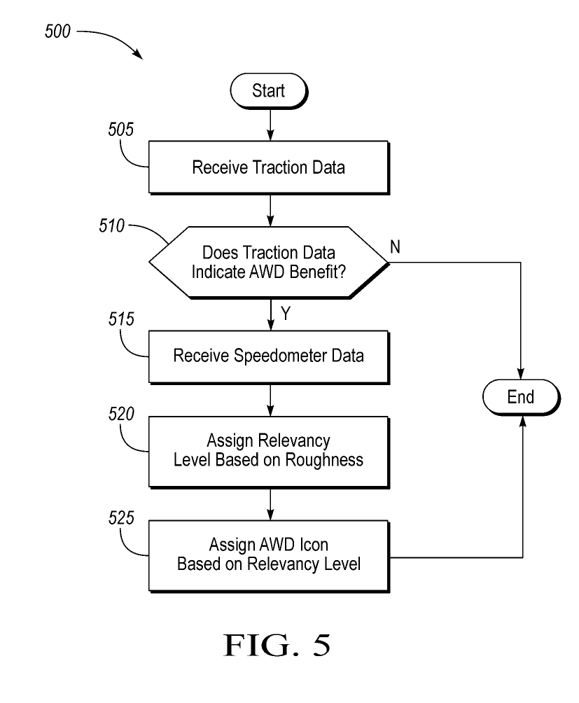

FIG. 5 illustrates an example process 500 for the vehicle display system 100 where a relevancy level and a corresponding display form is determined for the AWD icon 408. The process 500 beings at block 505 where the computing platform 104 receives traction data from the traction sensors 186. As explained, the traction data may be transmitted from one or more traction sensors 186 and may include data indicative of the current type of road surface. For example, traction data may indicate whether the surface is smooth or paved. The data may also indicate that the surface is uneven or slippery, thus indicated a level of roughness.

At block 510, the computing platform 104 may determine whether the traction data indicates a surface type in which the vehicle 102 may benefit from using AWD. That is, the computing platform 104 may determine whether the road is bumpy or slippery. If so, the process 500 proceeds to block 515. If not, the process 500 ends.

At block 515, the computing platform 104 may receive vehicle speed data indicating the current vehicle speed. The vehicle speed data may be received from the vehicle speed sensor 190.

At block 520, the computing platform 104 may assign a relevancy level to the AWD icon 408 based on the roughness. In this example, the higher the roughness, the more likely the vehicle 102 would benefit from the AWD feature and thus the higher the relevancy level. Additionally or alternatively, the vehicle speed may also affect the relevancy level in that the higher the speed, the higher the relevancy level.

At block 525, once the relevancy level has been established, the computing platform 104 may determine how the AWD icon 408 is displayed on the display 138 based on the relevancy level. In the example shown in FIG. 4, the computing platform 104 may decide which size of icon to display. The process 500 may then end.

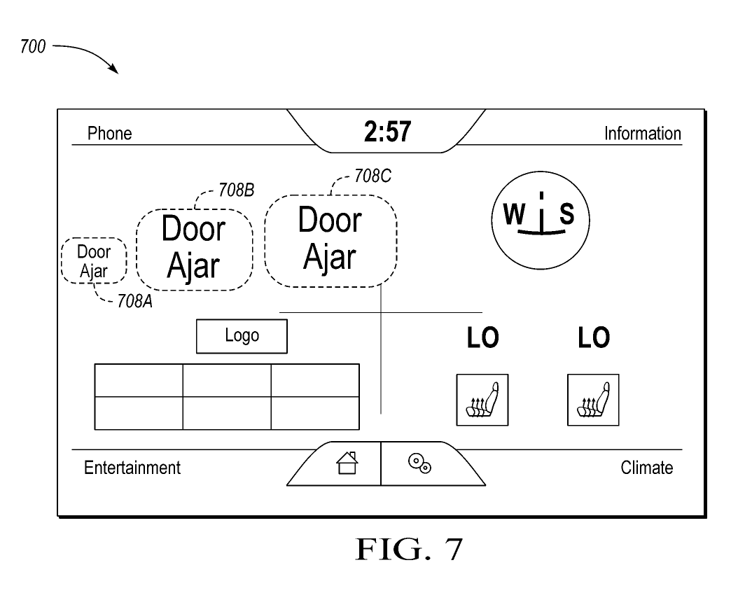

FIG. 6 illustrates an example graph of feature relevancy level of a door-ajar icon as a function of speed. The door-ajar icon (as shown as icon 708 in FIG. 7) may include a door-ajar alert indicating that a vehicle door is currently ajar, or not completely closed. During driving, the door-ajar icon may be presented via the display 138 to alert the driver to the open door. Although not shown herein, the door-ajar icon may indicate which of the vehicle doors is ajar. Door-ajar data may be provided to the processor 106 via the door sensors 188. As vehicle speed increases, as detected by the vehicle speed sensor 190, the relevancy of the door-ajar icon may also increase. That is, the faster the vehicle 102 is driving, the more relevant the door-ajar alert may become.

FIG. 7 illustrates another example vehicle display showing an interface 700 having various door-ajar icons 708. For illustrative purposes, the door-ajar icons 708 are shown as a small icon 708A, medium icon 708B, and large icon 708C. The various icon sizes may correspond to a level of relevancy for the specific feature presented by the icons. For example, if the door-ajar alert is of a low relevancy, the small icon 408A may be presented. However, as the relevancy increase, so may the size of the icon. The converse is also true, as the relevancy decreases, so may the size of the icon.

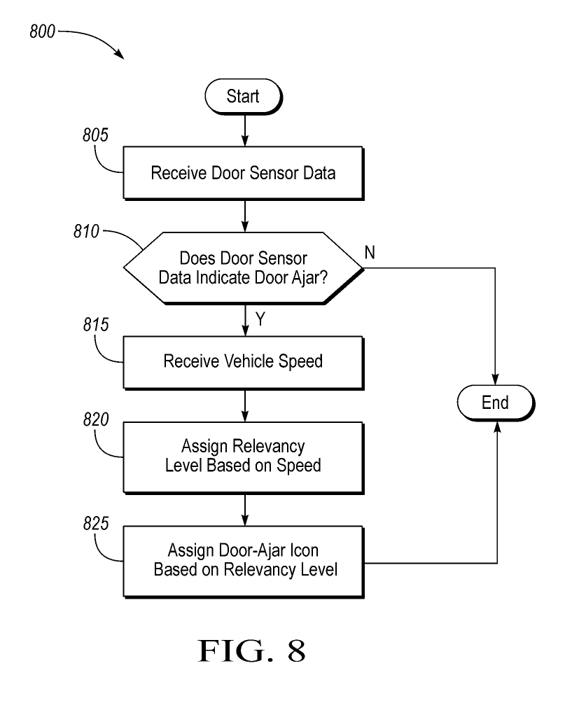

FIG. 8 illustrates another example process 800 for the vehicle display system 100 where a relevancy level and corresponding display form is determined for the door-ajar icon 708. The process 800 begins at block 705 where the computing platform 104 receives door sensor data from the door sensors 188. As explained, the door sensors 188 may include latches and may be configured to transmit door-ajar signals to the processor 106 in response to a respective vehicle door not being fully latched closed.

At block 810, the computing platform 104 may determine whether the door sensor data indicates a door is ajar. If so, the process 800 proceeds to block 815. If not, the process 800 ends.

At block 815, the computing platform may receive vehicle speed data indicating the current vehicle speed.

At block 820, the computing platform 104 may assign a relevancy level to the door-ajar icon 708 based on the vehicle speed. In this example, the higher the speed, the more relevant the door-ajar icon 708 and thus the higher level of relevancy.

At block 825, once the relevancy level has been established, the computing platform 104 may determine how the door-ajar icon 708 is displayed on the display 138 based on the relevancy level. In the example shown in FIG. 7, the computing platform 104 may decide which size of icon to display. The process 800 may then end.

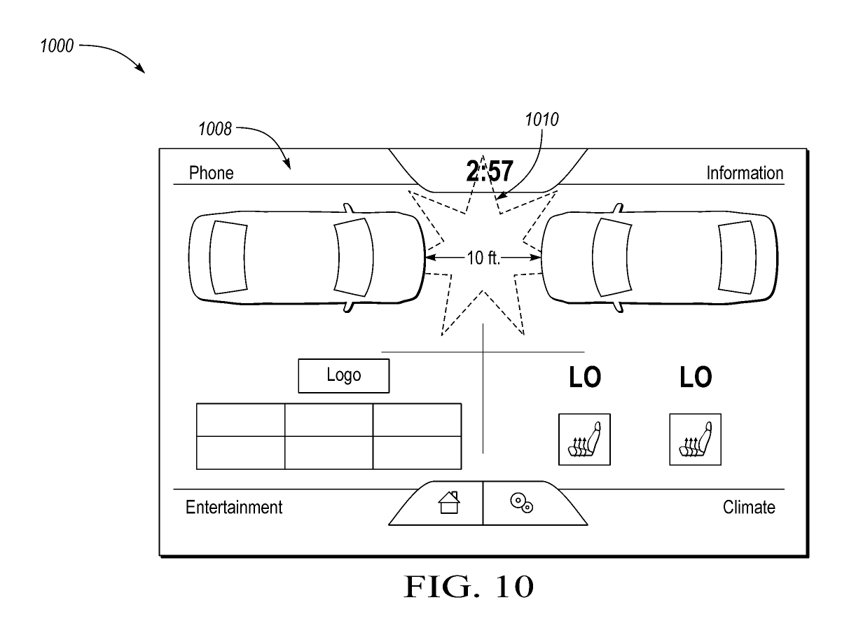

FIG. 9 illustrates another example graph of vehicle feature relevancy level of a collision-avoidance icon as a function of distance between the vehicle 102 and the followed vehicle. The collision-avoidance icon (as shown as icon 1008 in FIG. 10) may include a pictorial representation of a collision. The icon may also include a textual alert as well as a numeric representation of the distance to the followed vehicle. The processor 106 may determine whether vehicle position data received from the followed vehicle indicates that the position of the followed vehicle and the position of the vehicle 102 are within a close range of one another (e.g., approximately 10 meters, depending on the speed of the vehicle 102). As the vehicle 102 approaches the followed vehicle, the relevancy level of the collision-avoidance icon may increase as the vehicle 102 moves closer to the followed vehicle, and vice versa. Additionally or alternatively, the relevancy level may increase as the vehicle speed increases.

FIG. 10 illustrates an example vehicle display 138 showing an interface 1000 with a collision-avoidance icon 1008. The collision-avoidance icon 1008 may increase or decrease in size based on the relevancy level of the icon. Moreover, the collision-avoidance icon 108 may include an animated portion 1010 that may blink, scroll, flash, etc. In one example, if the collision-avoidance feature is associated with a low relevancy level, the icon 1008 may simply appear. If the feature is associated with a medium relevancy level, the animated portion 1010 may blink. If the feature is associated with a high relevancy level, the feature 1010 may flash or change colors.

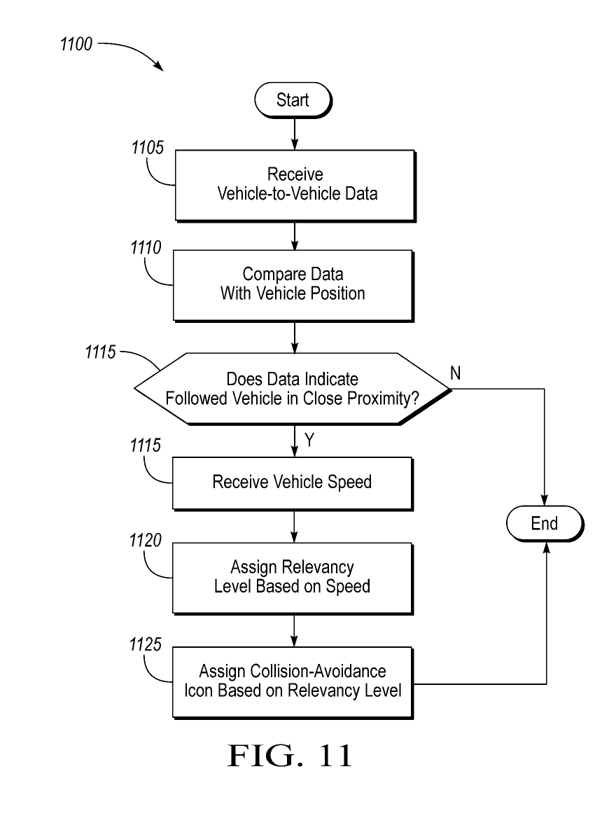

FIG. 11 illustrates another example process 1100 for the vehicle display system 100 where a relevancy level and corresponding display form is determined for the collision-avoidance icon 1008. The process 1100 begins at block 1105 where the computing platform 104 receives vehicle-to-vehicle data via the wireless transceiver 150 from another vehicle. As explained, the other vehicle may be a followed vehicle directly in front of the vehicle 102. The vehicle-to-vehicle data may include vehicle position data.

At block 1110, the computing platform 104 may determine whether the followed vehicle is in close proximity to the vehicle 102. This may be done by determining a distance between the two vehicles using GPS data and vehicle position data. If the vehicles are within a close proximity, or certain range of one another (e.g., within 10 meters), the process 1100 proceeds to block 115. If not, the process 1100 ends.

At block 1115, the computing platform may receive vehicle speed data indicating the current vehicle speed.

At block 1120, the computing platform 104 may assign a relevancy level to the collision-avoidance icon 1108 based on the vehicle speed. In this example, the higher the speed, the more relevant the collision-avoidance icon 1108 and thus the higher level of relevancy. Additionally or alternatively, the relevancy level may be assigned based on the distance between the two vehicles. The closer the vehicle 102 is following the followed vehicle, the higher the chance for a collision and thus a higher relevancy level should be assigned to the collision-avoidance icon.

At block 1125, once the relevancy level has been established, the computing platform 104 may determine how the collision-avoidance icon 1108 is displayed on the display 138 based on the relevancy level. In the example shown in FIG. 10, the computing platform 104 may decide which how the animated portion 1010 is animated. The process 1100 may then end.

FIG. 12 illustrates another example graph of vehicle feature relevancy level of a volume icon as a function of distance to a location of an emergency situation. The emergency situation may be a traffic accident, or other event such as a fire. Furthermore, the emergency situation may be the presence of an emergency vehicle such as an ambulance, police vehicle, fire response vehicle, etc., within close proximity (e.g., half of a mile) to the vehicle 102. The location of the emergency situation may be transmitted via vehicle-to-vehicle communication. The location may also be approximated by detection of an emergency vehicle siren via the microphone 182. The relevancy level of the volume feature may increase as the distance to the emergency location decreases. That is, as the vehicle 102 approaches the emergency location, the volume of vehicle speakers may be relevant in order to hear incoming sirens, as well as allow for more focus of the situation.

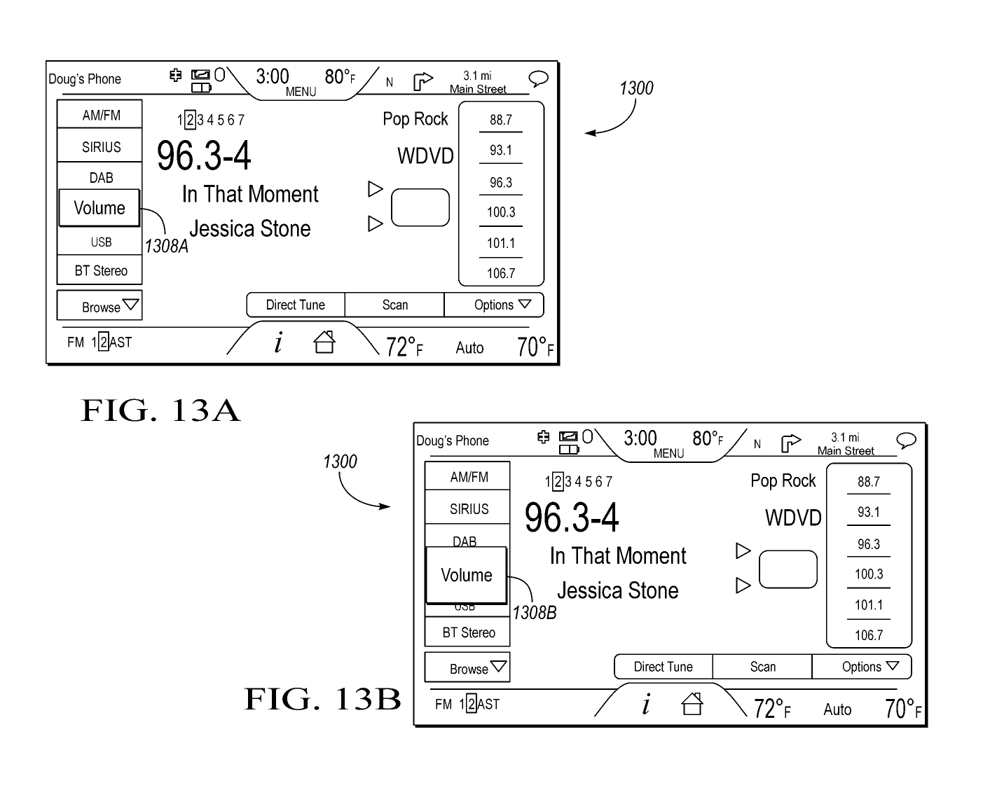

FIGS. 13A and 13B each illustrates another example vehicle display showing an interface 1300 with a volume icon 1308. FIG. 13A illustrates an interface 1300 having a volume icon 1308A of a first size and FIG. 13B illustrates an interface 1300 having a volume icon 1308B of a second size. The first size may be smaller than the second size. The first size may correspond to a low relevancy level while the second size may correspond to a high relevancy level. Other icon sizes may also be displayed. As the vehicle 105 approaches the relevance level and size of the icon 1308 may increase from the first size to the second size so as to gain the attention of the driver.

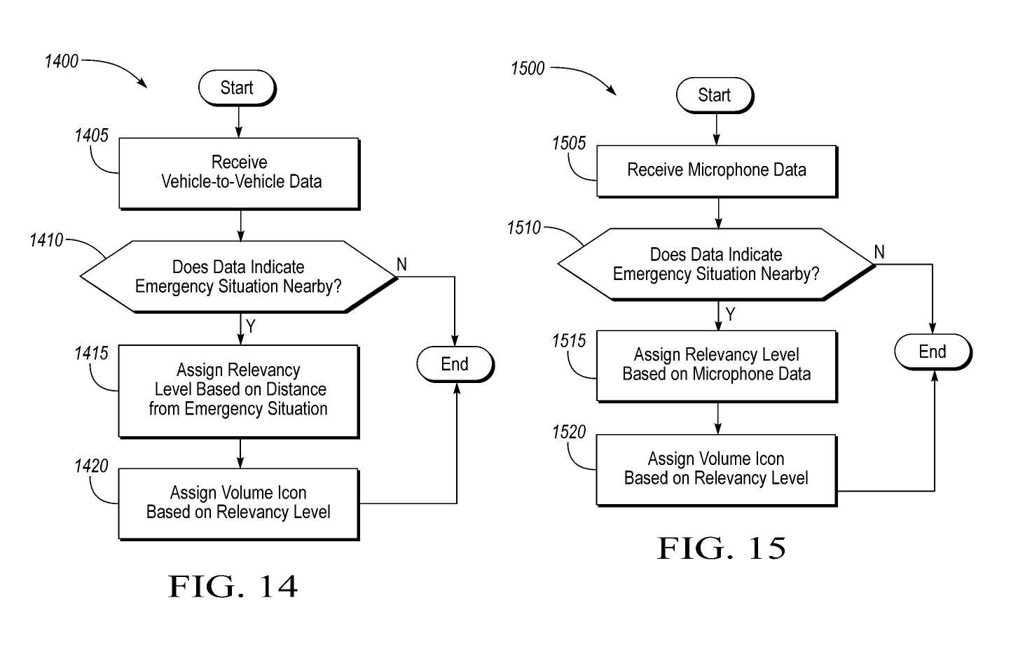

FIG. 14 illustrates another example process for the vehicle display system 100 for the vehicle display system 100 where a relevancy level and corresponding display form is determined for the volume icon 1308. The process 1400 begins at block 1405 where the computing platform 104 receives vehicle-to-vehicle data via the wireless transceiver 150 from another vehicle. The vehicle-to-vehicle data may include emergency location data.

At block 1410, the computing platform 104 may determine whether the emergency situation is located in close proximity to the vehicle 102. This may be done by determining a distance between the vehicle and the emergency situation using GPS data. If the emergency situation is within a predefined distance of the vehicle 102 (e.g., within a half of a mile), the process 1400 proceeds to block 1415. If not, the process ends.

At block 1415, the computing platform 104 may assign a relevancy level to the volume icon 1308 based on the distance from the emergency situation. In this example, the shorter the distance, the more relevant the volume icon 1308 and thus the higher level of relevancy.

At block 1420, once the relevancy level has been established, the computing platform 104 may determine how the volume icon 1308 is displayed on the display 138 based on the relevancy level. In the example shown in FIG. 13, the computing platform 104 may decide the size of the icon. The process 1400 may then end.

FIG. 15 illustrates another example process 1500 for the vehicle display system for the vehicle display system 100 where a relevancy level and corresponding display form is determined for the volume icon 1308. The process 1500 begins at block 1505 where the computing platform 104 receives microphone data via the microphone 182. The microphone data may include data representative of ambient noise outside of the vehicle 102 and may include a siren, or other alarm.

At block 1510, the computing platform 104 may determine whether the microphone data includes data representative of a siren or other alarm. This may be done by distinguishing between ambient noise and siren noise frequency and amplitude profiles. If data is indicative of a siren or alarm is recognized, the process 1500 proceeds to block 1515. If not, the process ends.

At block 1515, the computing platform 104 may assign a relevancy level to the volume icon 1308 based on the microphone data. In this example, the presence of data indicative of a siren may cause the relevancy level to be high. That is, if the microphone 182 is close enough to pick up a siren noise, then the vehicle 102 may be inferred to be in close proximity to the source of the siren.

At block 1520, once the relevancy level has been established, the computing platform 104 may determine how the volume icon 1308 is displayed on the display 138 based on the relevancy level. In the example shown in FIG. 13, the computing platform 104 may select the size of the icon. The process 1500 may then end.

While specific examples are shown via the interfaces 400, 700, 1000, 1300 and processes 500, 800, 1100, 1400 as described above, it may be appreciated that these are exemplary and not limiting. For example, while the size of certain icons is described with respect to interfaces 400 and 700, the AWD icons 408 and door-ajar icons 708 may be animated similar to the discussions with respect to FIGS. 10 and 11. The collision-avoidance icon 1008 may also be adjusted in size according to the relevancy level associated therewith.

Furthermore, while the interfaces are described as being presented via display 138, the interfaces may also be presented via a heads-up display (HUD), and/or mobile display 176.

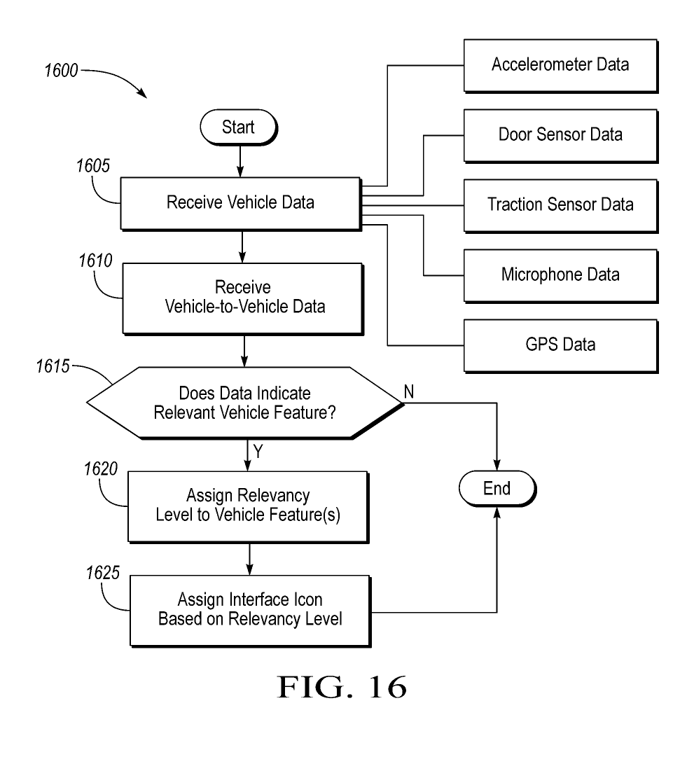

FIG. 16 illustrates another example process for the vehicle display system 100 where a relevancy level and a corresponding display form is determined for various vehicle icons (as shown by way of example as icons 408, 708, 1008, and 1308.) As explained, a relevancy level is assigned to an icon associated with a vehicle feature based on vehicle data (e.g., microphone data, vehicle speed data, accelerometer data, sensor data, GPS data, etc.) and/or vehicle-to-vehicle data. The relevancy level may then be used to assign a display form for the associated icon. By displaying icons in terms of their relevancy, user interaction with the display 138 may increase and distractions may decrease. Furthermore, use a certain vehicle features may be encourages, also adding to an enhanced driving experience.

At block 1605, the computing platform 104 may receive vehicle data. Vehicle data may include data from the vehicle ECUs 148, GPS module 146, and other internal vehicle systems. This data may provide information relevant to certain alerts, or vehicle features.

At block 1610, the computing platform 104 may receive vehicle-to-vehicle data. The vehicle-to-vehicle data may include followed vehicle position data, emergency situation data, etc. This data may also relate to certain vehicle alerts and features.

At block 1615, the computing platform 104 may determine whether the vehicle data or the vehicle-to-vehicle data are relevant to a certain vehicle feature. For example, if a door is ajar, this may be determined to be relevant data. In another example, if a surface road is uneven, this may be determined to be relevant data. If any of the received data is determined to be relevant, the process 1600 proceeds to block 1620. If not, the process 1600 ends.

At block 1620, the computing platform 104 may assign a relevancy level based on the received data, as discussed above with respect to the specific examples. For example, the faster the vehicle 102 is moving while a door is ajar, the higher the relevancy level of the door-ajar icon 708.

At block 1625, once the relevancy level has been established for a certain icon, the computing platform 104 may determine how the icon is displayed on the display 138 based on the relevancy level. As explained, several icon display forms may be used including varying sizes, animations, colors, pictorial representations, etc. The process 1600 may then end.

While the above processes are described as being performed by the computing platform 104, the processes may also be carried out by other components, controllers, and processors, for example, components within the mobile device 116, remote server 162, etc.

Accordingly, a display system as described herein may use vehicle data and vehicle-to-vehicle data to determine a display form of a certain icon. A relevancy level may then be used to determine the display form for the associated icon. By displaying icons in terms of their relevancy, user interaction with the display 138 may increase and distractions may decrease. Furthermore, use a certain vehicle features may be encourages, also adding to an enhanced driving experience.

Computing devices, such as the mixer, remote device, external server, etc., generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included with in a computing device employing a computer operating system such as one of those mentioned above, and are accessed via a network and any one or more of a variety of manners. A file system may be accessible for a computer operating system, and make the files stored in various formats. An RDBMS generally employs the Structure Query Language (SQL) in addition to language for creating, storing, editing, and executing stored procedures, such as PL/SQL language mentioned above.

In some examples, system elements may be implemented as computer-readable instructions (e.g., software) on one or more computing devices (e.g., servers, personal computers, etc.) stored on computer readable media associated there with (e.g., disks, memories, etc.). A computer program product may comprise such instructions stored in computer readable media for carrying out the functions described herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle display system comprising:
an interface configured to present selectable icons; and
a controller programmed to receive data indicating a roughness of a driving surface, to assign a relevancy level to at least one of the icons associated with a vehicle feature based on the data, and to select a display form for the at least one of the icons based on the relevancy level, wherein the relevancy level increases as the roughness increases.

2. The display system of claim 1, wherein the data is indicative of a vehicle speed and wherein the relevancy level increases as the vehicle speed increases.

3. (canceled)

4. The display system of claim 1, wherein the at least one of the icons includes an all-wheel-drive icon associated with an all-wheel-drive feature or a four-wheel-drive feature.

5. The display system of claim 1, wherein the data is indicative of a status of at least one vehicle door and wherein the relevancy level increases in response to a change from a closed status to an open status.

6. The display system of claim 5, wherein the at least one icon includes a door-ajar icon in response to the data indicating the open status.

7. The display system of claim 1, wherein the at least one of the icons includes a collision-avoidance icon.

8. The display system of claim 7, wherein the relevancy level increases as a distance to a followed vehicle decreases.

9. A vehicle having a vehicle display system, comprising:
an interface configured to present a collision-avoidance icon; and
a controller programmed to receive vehicle position data indicative of a followed vehicle position, to assign a relevancy level to the icon based on the followed vehicle position, and to select a display form for the icon based on the relevancy level.

10. The vehicle of claim 9, wherein the relevancy level increases as a distance between the followed vehicle position and a current vehicle position decreases.

11. The vehicle of claim 9, wherein the display form includes an icon size and wherein the icon size increases as the relevancy level increases.

12. The vehicle of claim 9, wherein the display form includes an animated feature.

13. A vehicle display system comprising:
an interface configured to present an icon that permits control of vehicle speaker volume; and
a controller programmed to alter a display form of the icon based on an assigned relevancy level that changes as received data indicative of an emergency situation changes.

14. The display system of claim 13, wherein the data includes an emergency location.

15. The display system of claim 14, wherein the relevancy level increases as a distance between the emergency location and a current vehicle location decreases.

16. The display system of claim 13, further comprising a microphone configured to detect ambient noise, wherein the data includes microphone data indicative of a siren.

17. The display system of claim 16, wherein the relevancy level is at a highest level in response to the microphone data being indicative of a siren.
